(19) United States
(12) Patent Application Publication
(10) Pub. No.: US 2004/0066620 A1
(43) Pub. Date: Apr. 8, 2004

(54) Device to allow computers to adapt to multiple docking stations

(75) Inventors: David W. Grunow, Round Rock, TX (US); Terry A. Kingsmore JR., Pflugerville, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX

(21) Appl. No.: 10/266,243

(22) Filed: Oct. 8, 2002

(51) Int. Cl. G06F 1/16

(52) U.S. Cl. 361/686; 361/683; 710/303; 395/281

(57) ABSTRACT

A multiple docking system includes a portable computer having a first docking connector extending in a first direction and a docking station having a second docking connector extending in a direction substantially orthogonal to the first direction. A converter has mating interconnections for each of the first and second connectors. The converter may provide expanded functionality including floppy and CD-ROM functionality.

### BACKGROUND

The disclosures herein relate generally to information handling systems and more particularly to docking stations for portable computer systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Known docking solutions are available to provide cable management of pass-through connections for various portable computer functions by means of a single connector.

One docking solution provides a rearwardly extending connection on the portable computer which connects to an opposed, forwardly extending connector on a docking station. This is often referred to as a Rear-dock. Another docking solution provides a bottom downwardly extending connection on the portable computer which connects to an opposed upwardly extending connector on a docking station. This is often referred to as a Bottom-dock.

Another known docking solution is often referred to as a media slice which provides the user with a portable docking solution with greater functionality, such as added input/output (I/O) ports, spindle drives, better speakers, CD-Rom and floppy. Thus, the media slice is a portable Bottom-dock with added functionality.

A problem arises therefore if a user has only a Rear-dock docking solution and cannot therefore connect to a Bottom-dock connector on a portable computer.

Therefore, what is needed is a docking converter which permits a Bottom-dock connector on a portable computer to be linked to a Rear-dock connector on a docking solution, either with or without the added functionality discussed above.

### SUMMARY

One embodiment, accordingly, provides an apparatus for docking to multiple docking stations. To this end, a portable computer has a first docking connector extending in a first direction. A docking station has a second docking connector extending in a direction offset from the first direction. A converter is provided to interconnect the first and second connectors.

A principal advantage of this embodiment is that a docking converter is provided either with or without the expanded functionality.

### BRIEF DESCRIPTION OF THE DRAWINGS

FIG. 1 is a diagrammatic view illustrating an embodiment of a computer system.

FIG. 2. is a side view illustrating an embodiment of a docking system.

FIG. 2A is a side view illustrating another embodiment of a docking system.

FIG. 3 is a perspective view illustrating an embodiment of a docking system.

FIG. 4 is a perspective view illustrating an embodiment of a docking converter.

FIG. 5 is a perspective view illustrating another embodiment of a docking converter.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

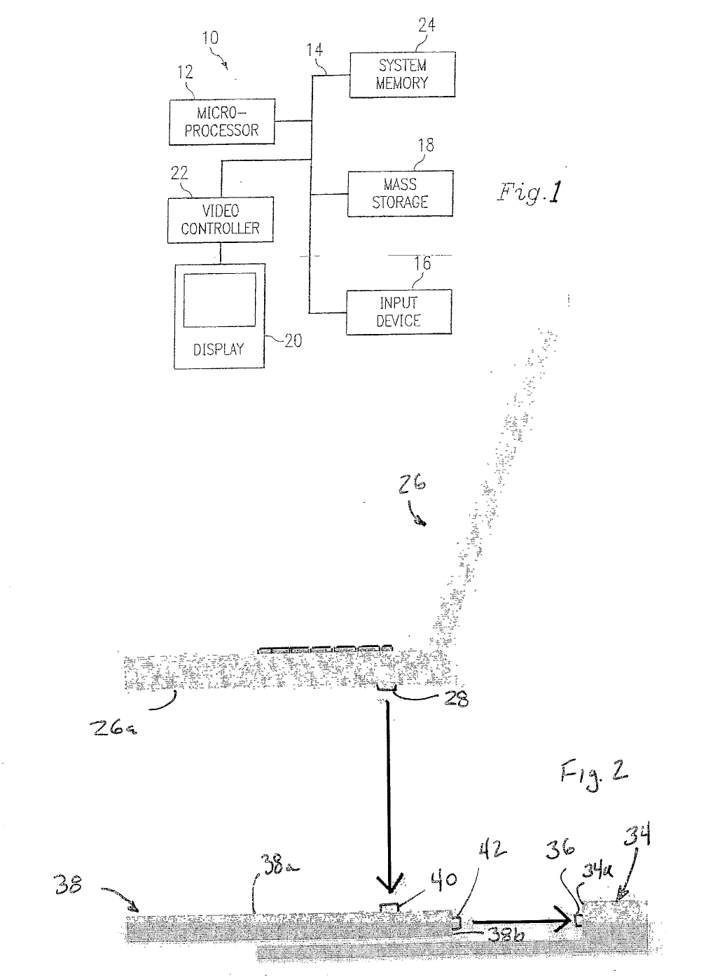

In one embodiment, computer system 10, FIG. 1, includes a microprocessor 12, which is connected to a bus 14. Bus 14 serves as a connection between microprocessor 12 and other components of computer system 10. An input device 16 is coupled to microprocessor 12 to provide input to microprocessor 12. Examples of input devices include keyboards, touchscreens, and pointing devices such as mouses, trackballs and trackpads. Programs and data are stored on a mass storage device 18, which is coupled to microprocessor 12. Mass storage devices include such devices as hard disks, optical disks, magneto-optical drives, floppy drives and the like. Computer system 10 further includes a display 20, which is coupled to microprocessor 12 by a video controller 22. A system memory 24 is coupled to microprocessor 12 to provide the microprocessor with fast storage to facilitate execution of computer programs by microprocessor 12. It should be understood that other busses and intermediate circuits can be deployed between the components described above and microprocessor 12 to facilitate interconnection between the components and the microprocessor.

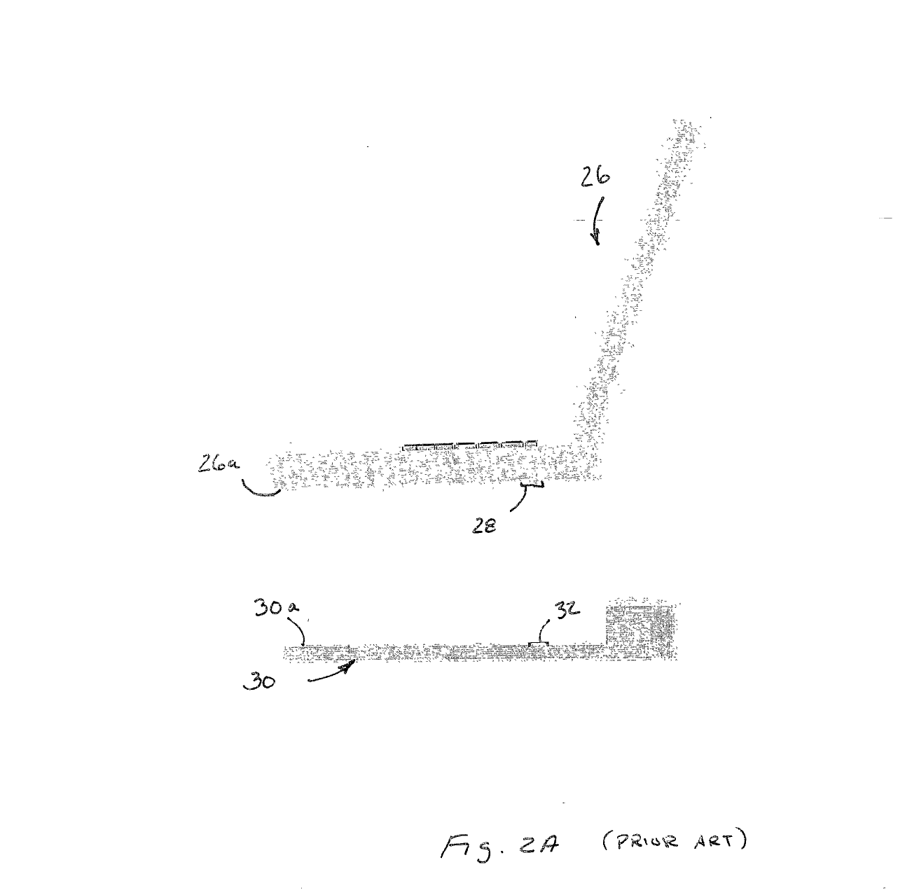

In FIG. 2A, a classic Bottom-dock arrangement is illustrated. A portable computer 26, which includes a self-contained system such as that described at 10 in FIG. 1, includes a docking connector 28 which is directed downwardly from a bottom surface 26a of computer 26. A docking solution 30 includes a direct docking connector 32 extending upwardly from an upper surface 30a of docking solution 30. Connector 32 is aligned for engagement with connector 28.

A user having portable computer 26 may only have access to a Rear-dock docking solution 34, FIG. 2, which includes a forwardly directed docking connector 36 extending from a surface 34a by using a converter member 38. It can be seen that connector 36 is offset from and substantially orthogonal to connector 28 of computer 26.

The converter member 38 includes mating interconnections for the connectors 28 and 36. For example, converter member 38 includes a connector 40 directed upwardly from a surface 38a and extending toward connector 28. Also, converter member 38 includes a connector 42 directed rearwardly from a surface 38b and extending toward connector 36.

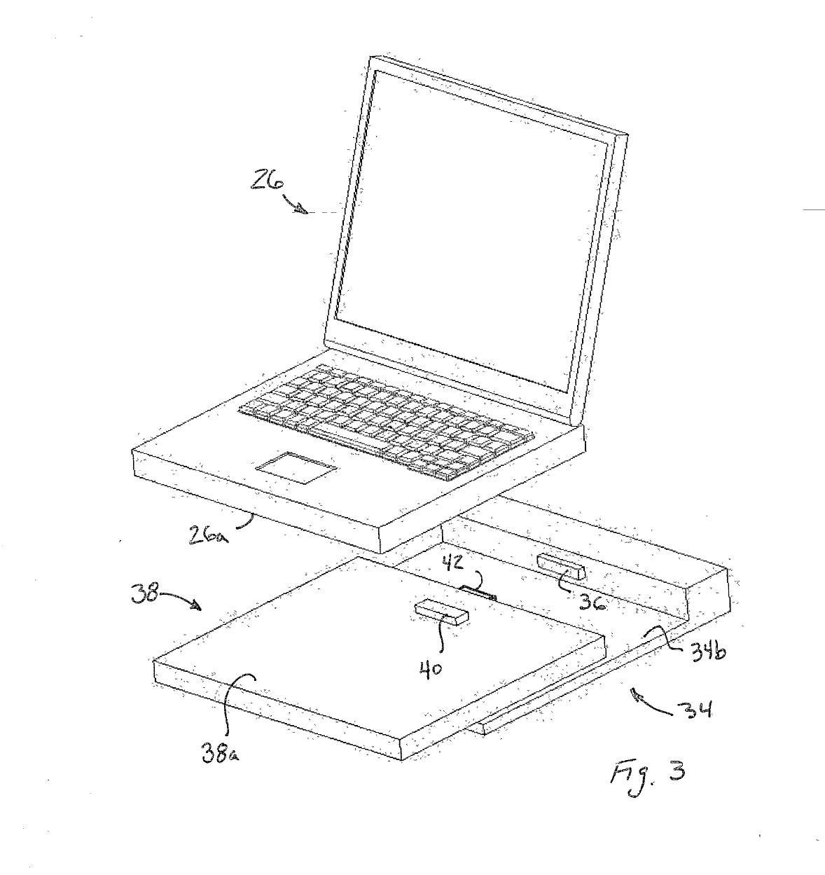

In a perspective view, FIG. 3, computer 26 is positioned for seating on converter member 38, however, connector 28 is not viewable in FIG. 3. Surface 38a of converter member 38 faces upwardly toward surface 26a of computer 26 and connector 40 extends upwardly toward surface 26a which includes the connector 28 (not shown).

Converter member 38 is seated on a support surface 34b of docking solution 34, and connector 42 extends rearwardly toward forwardly extending connector 36.

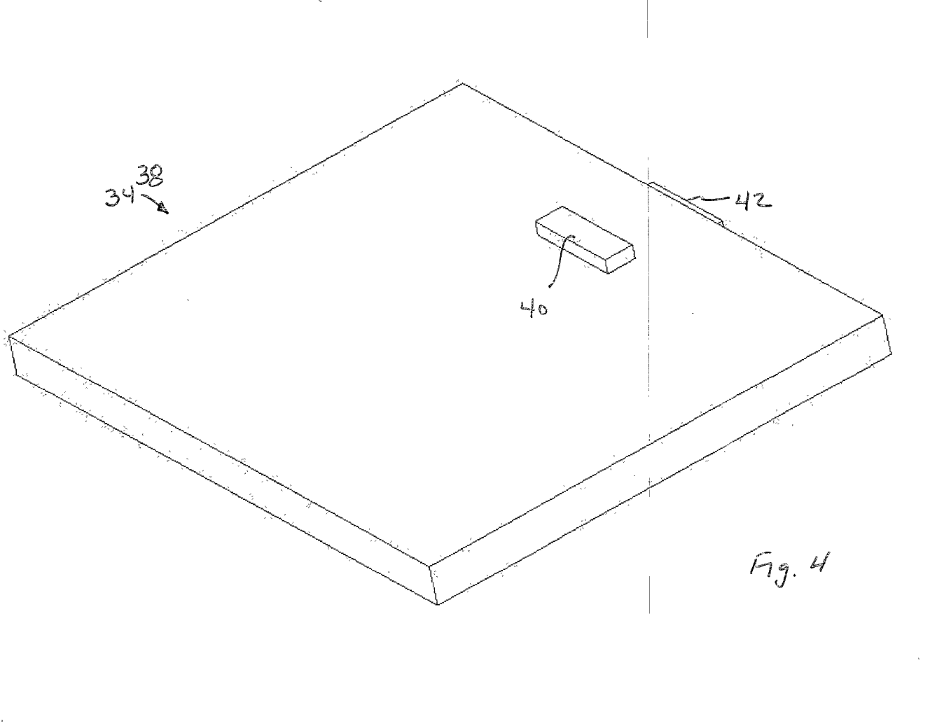

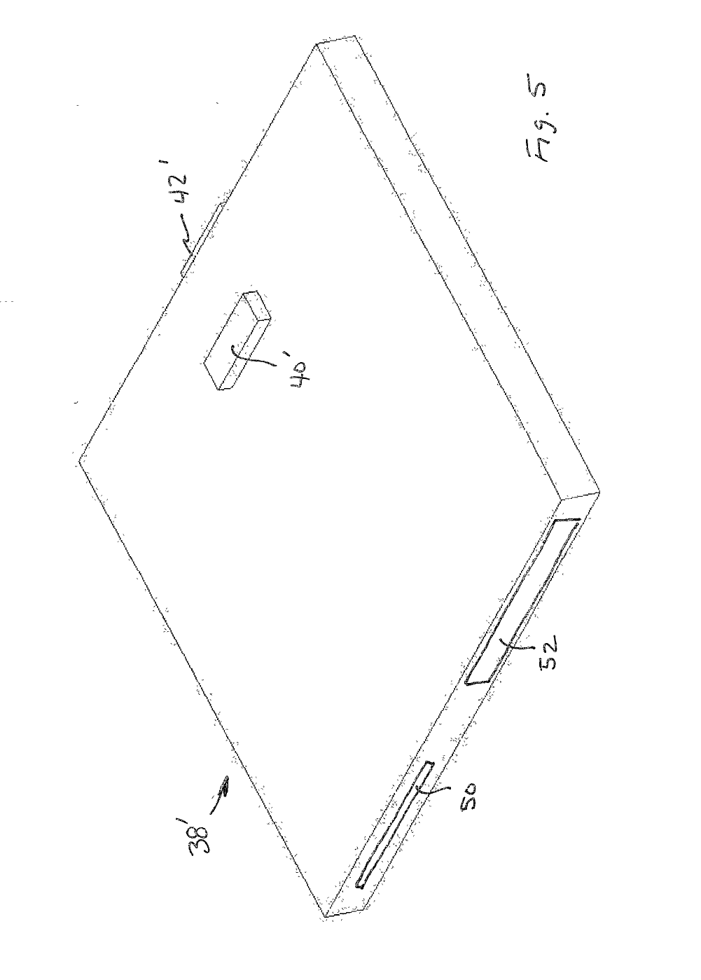

Converter member 38, FIG. 4, may function as a portable converter only by providing the connectors 40 and 42 along with the required electrical interconnections to connect computer 26 to docking solution 34. Alternatively, a converter member 38, FIG. 5, may comprise a portable media slice including not only connectors 40′ and 42′, but added functionality such as for example, a slot 50 for a floppy disk insertion, and an extendable carrier 52 for CD-ROM insertion.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. Apparatus for docking to multiple docking stations comprising:
a portable computer having a first docking connector extending in a first direction;
a docking station having a second docking connector extending in a direction offset from the first direction; and
a converter member having mating interconnections for each of the first and second connectors.

2. The apparatus as defined in claim 1 wherein the first docking connector is orthogonally disposed to the second docking connector.

3. The apparatus as defined in claim 1 wherein the converter member includes expanded functionality.

4. The apparatus as defined in claim 3 wherein the expanded functionality includes floppy and CD-ROM functionality.

5. A multiple docking system comprising:
a portable computer having a first docking connector extending in a first direction;
a docking station having a second docking connector extending in a direction substantially orthogonal to the first direction;
a first converter having mating interconnections for each of the first and second connectors; and
a second converter having mating interconnections for each of the first and second connectors and having expanded functionality including floppy and CD-ROM functionality.

6. The system as defined in claim 5 wherein the first and second converters are portable.

7. A method of providing multiple docking solutions comprising:
providing a portable computer having a first docking connector extending in a first direction;
providing a docking station having a second connector extending in a direction offset from the first direction; and
interconnecting the portable computer and the docking station by a converter member having mating interconnections for each of the first and second connectors.

8. The method as defined in claim 7 further comprising:
orthogonally disposing the first docking connector to the second docking connector.

9. The method as defined in claim 7 further comprising:
providing expanded functionality in the converter member.

10. The method as defined in claim 7 further comprising:
providing floppy and CD-ROM functionality in the converter member.

11. A method of providing multiple docking solutions comprising:
providing a portable computer having a first docking connector extending in a first direction;
providing a docking station having a second connector extending in a direction substantially orthogonal to the first direction;
interconnecting the portable computer and the docking station by selecting one of:
a) a first converter having mating interconnections for each of the first and second connectors; and
b) a second converter having mating interconnections for each of the first and second connectors and having expanded functionality including floppy and CD-ROM functionality.

12. The method as defined in claim 11 wherein the first and second converters are portable.

13. A multiple docking system comprising:
a portable computer having a first docking connector extending in a first direction;
a first docking station having a direct docking connector aligned for engagement with the first docking connector;
a second docking station having a second docking connector extending in a direction offset from the first direction; and
a converter member having mating interconnections for each of the first and second connectors.

14. The system as defined in claim 13 wherein the first docking connector is orthogonally disposed to the second docking connector.

15. The system as defined in claim 13 wherein the converter member includes expanded functionality.

16. The system as defined in claim 13 wherein the converter member includes floppy and CD-ROM functionality.

17. A multiple docking system comprising:
a portable computer having a first docking connector extending in a first direction;
a first docking station having a direct docking connector aligned for engagement with the first docking connector;
a second docking station having a second docking connector extending in a direction substantially orthogonal to the first direction;
a first converter having mating interconnections for each of the first and second connectors; and
a second converter having mating interconnections for each of the first and second connectors and having expanded functionality including floppy and CD-ROM functionality.

18. The system as defined in claim 17 wherein the first and second converters are portable.

19. An information handling system comprising:
a chassis;
a microprocessor mounted in the chassis;
a storage coupled to the microprocessor;
the chassis having a first docking connector extending in a first direction;
a docking station having a second docking connector extending in a direction offset from the first direction; and
a converter member having mating interconnections for each of the first and second connectors.

20. An information handling system comprising:
a chassis;
a microprocessor mounted in the chassis;
a storage coupled to the microprocessor;
the chassis having a first docking connector extending in a first direction;
a docking station having a second docking connector extending in a direction substantially orthogonal to the first direction;
a first converter having mating interconnections for each of the first and second connectors; and
a second converter having mating interconnections for each of the first and second connectors and having expanded functionality including floppy and CD-ROM functionality.
